(19) United States
(12) Patent Application Publication
(10) Pub. No.: US 2026/0200774 A1
(43) Pub. Date: Jul. 16, 2026

(54) WATER TREATMENT ASSEMBLY AND METHOD

(71) Applicant: TotalEnergies OneTech, COURBEVOIE (FR)

(72) Inventors: Bruno DELAHAYE, PAU CEDEX (FR); Sébastien DEHEZ, PAU CEDEX (FR); Frédéric PERIE, PAU CEDEX (FR); Lorena ESCOBAR, PAU CEDEX (FR); El Hadji Ibrahima NDIAYE, PAU CEDEX (FR)

(73) Assignee: TotalEnergies OneTech, COURBEVOIE (FR)

(21) Appl. No.: 19/131,430

(22) PCT Filed: Nov. 29, 2022
(86) PCT No.: PCT/IB2022/000701

§ 371 Date: May 20, 2025

(51) Int. Cl. C02F 3/02; C02F 1/30; C02F 1/44

(52) U.S. Cl. CPC C02F 3/02; C02F 1/30; C02F 1/441; C02F 2201/008; C02F 2201/009; C02F 2303/10

(57) ABSTRACT

A water treatment assembly includes a water treatment system including at least one ventilation device for ventilating water treated in the water treatment system, a compressed air system for producing and storing compressed air, the compressed air system being configured for feeding compressed air to the ventilation device and/or to an electrical power unit configured for producing electrical energy from compressed air, and an electrical power system configured for producing electrical power with using at least one renewable energy source and for feeding the water treatment system and the compressed air system with electrical power. The water treatment assembly includes a heat management system configured for transferring heat from the electrical power system, the electrical power unit and/or the compressed air system to the water treatment system.

### CROSS REFERENCE TO RELATED APPLICATIONS

The present application is a U.S. National Phase Application under 35 U.S.C. § 371 of International Patent Application No. PCT/IB2022/000701 filed Nov. 29, 2022. The entire contents of which are hereby incorporated by reference.

### FIELD

The present invention relates to the treatment of water and in particular to a water treatment assembly.

### BACKGROUND

It is desirable to treat water retrieved from different sources for producing water usable for different purposes, including for drinking. It is also desirable to treat water in an efficient manner in terms of energy consumption.

One of the aims of the invention is to provide a water treatment assembly that allows improving efficiency of water treatment.

### SUMMARY

To this end, the invention proposes a water treatment assembly comprising a water treatment system configured for treating water, the water treatment system comprising at least one ventilation device for ventilating water treated in the water treatment system, a compressed air system configured for producing and storing compressed air, the compressed air system being configured for feeding compressed air to the ventilation device and/or to an electrical power unit configured for producing electrical energy from compressed air, and an electrical power system configured for producing electrical power with using at least one renewable energy source and for feeding the water treatment system and the compressed air system with electrical power, wherein the water treatment assembly comprises a heat management system configured for transferring heat from the electrical power system, the electrical power unit and/or the compressed air system to the water treatment system.

The compressed air system configured for storing compressed air and fed with electricity generated by the electrical power system making use of renewable energy allows storing energy in the form of compressed air. Energy can be stored when renewable energy is available (under sunny conditions when using photovoltaic panels or under windy conditions when using wind turbines for example) and released later, e.g. when renewable energy is not sufficient.

Compressed air stored in the compressed air system is fed to the ventilation device of the water treatment system and/or to the electrical power unit configured for converting compressed air into electrical power (i.e. configured for using compressed air to generate electrical power, e.g. through turbines or generators). The electrical power is used for example by the water treatment system, in particular by the ventilation device, e.g. for feeding fans, motor or pumps.

Electrical power generation and compressed air generation are likely to generate heat. The heat management system configured for transferring heat from the electrical power system and/or the compressed air system to the water treatment system allows cooling down the electrical power system and/or the compressed air system and using this thermal energy to heat up the water treatment system. The overall efficiency of the water treatment assembly is also improved.

According to specific embodiments, the water treatment assembly comprises one or several of the following features, taken individually or in any technically feasible combination:
the water treatment system comprises a bioreactor, the ventilation device being arranged for ventilation of water treated in the bioreactor;
the water treatment system comprises a separator fluidly connected to the bioreactor for physically separating impurities from water treated in the bioreactor;
the bioreactor is a bioreactor with free biomass, a bioreactor with supported biomass or a photobioreactor;
the water treatment system comprises a reverse osmose device configured for purifying a water stream by implementing reverse osmosis;
the compressed air system comprises at least one compressor configured for compressing air and at least one air reservoir for storing compressed air;
the electrical power unit is configured for providing electrical power to the ventilation device;
the ventilation device is configured for generating air bubbles using electrical power;
the ventilation device is configured for generating air bubbles using compressed air provided by the compressed air system;
the electrical power system comprises at least one wind turbine for producing electrical power using wind energy, at least one geothermal unit for producing electrical power using geothermal energy, at least one photovoltaic panel for producing electrical power using solar energy, at least one concentrated solar thermal power unit for producing electrical power from vapor generated by heating a fluid using concentrated solar energy, at least one wave energy converter for converting wave energy into electrical power and/or at least one tidal turbine for converting a water stream into electrical power;
the heat management system comprises at least one heat exchanger arranged for collecting heat from the electrical power system, the electrical power unit or the compressed air system and at least one heat exchanger arranged for releasing heat to water present in the water treatment system,
the water treatment assembly is, configured to be transported via road, sea and/or air;
the water treatment system, the compressed air system, the electrical power system, and the heat management system are housed in one normalized transport container or several normalized transport containers configured for being mutually connected for connecting the water treatment system, the compressed air system and the electrical power system together.

The invention also relates to water treatment method comprising the steps of treating water in a water treatment system with ventilating water in the water treatment system using a ventilation device, producing and storing compressed air with a compressed air system with feeding compressed air to the ventilation device and/or to an electrical power unit configured for producing electrical energy from compressed air, producing electrical power with a an electrical power system using at least one renewable energy source and feeding electrical power to the water treatment system and/or the compressed air system, wherein the water treatment method comprises transferring heat from the electrical power system, the electrical power unit and/or the compressed air system to the water treatment system.

### BRIEF DESCRIPTION OF THE DRAWINGS

The invention will be better understood, based on the following description, given solely an example made in reference to the appended drawings, in which:

FIG. 1 is diagrammatical view of a water treatment assembly; and

FIG. 2 is a diagrammatical view of a water treatment system of the water treatment assembly of FIG. 1.

### DETAILED DESCRIPTION

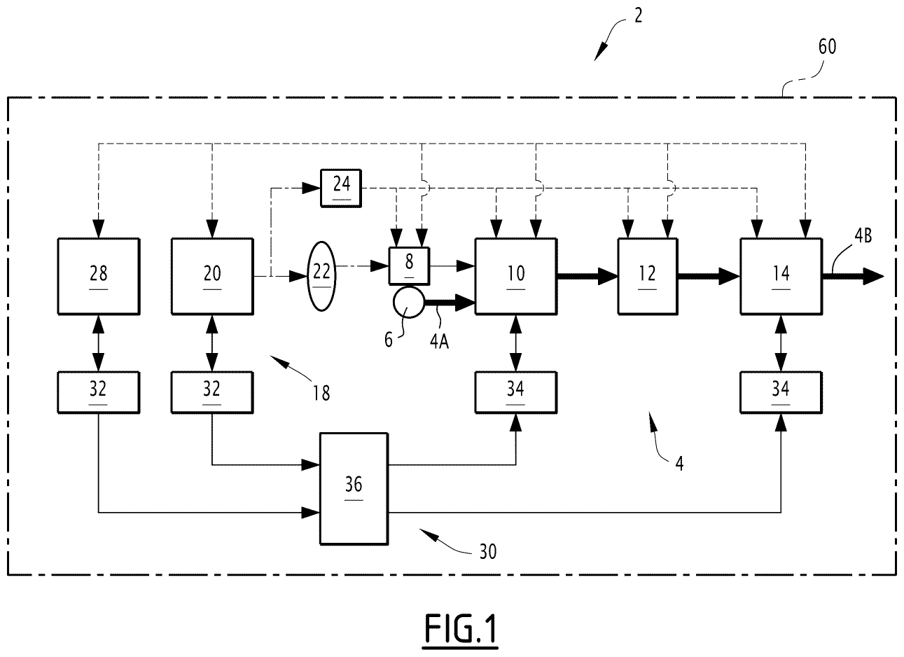

The water treatment assembly 2 of FIG. 1 is configured for treating water, e.g. for furnishing

The water treatment assembly 2 is designed for using at least in part renewable energy sources for providing the energy that is necessary for treating the water and for managing the heat in the water treatment assembly for optimizing the energy consumption.

The water treatment assembly 2 comprises a water treatment system 4 configured for receiving water at a water inlet 4A, treating the water and providing treated water at a water outlet 4B.

The water treatment system 4 is configured for reducing the content of contaminants and/or undesirable components of the water entering the water treatment system 4, as a function of the intended use of the water.

The water is provided at the water inlet 4A by a water source 6. The water source 6 may include one or several sources including (but not limited to): water from underground, water from rivers, water from lakes, water from glaciers, water from the sea, industrial water and wastewater.

The water treatment system 4 is configured for implementing one or several treatment technologies, including for example one or several chemical treatments (such as chlorination or aeration), one or several physical treatments such as sedimentation, filtration or degasification, one or several physicochemical treatments (such as flocculation and polyelectrolytes), one or several biological treatments, one or several electrochemical treatments, chemical precipitation, flotation, membrane filtration, ion exchange treatment and/or activated carbon treatment.

The water treatment system 4 comprises at least one ventilation device 8 configured for ventilating water treated in the water treatment system 4.

The term “ventilation” refers in a general manner to the injection of air in the water, for example for aeration of the water and/or agitation of the water.

Each ventilation device 8 is configured for example for injecting air bubbles into water treated in the water treatment system 4 for dissolving components of the air into the water, in particular for dissolving dioxygen (O₂) into the water, for providing air to microorganisms present in the water for water treatment and/or for agitating the water.

Advantageously, the water treatment system 4 comprises a bioreactor 10 for the biological treatment of the water.

Preferably, a ventilation device 8 of the water treatment system 4 is arranged to generate bubbles in water treated in the bioreactor 10.

Preferably, the water treatment system 4 comprises a separator 12 fluidly connected to the bioreactor 10 for receiving water treated in the bioreactor 10 and for physically separating impurities from the water.

The water treatment system 4 comprises for example at least one water treatment device configured for treating the water previously treated in the bioreactor 10.

Alternatively, water treated in the bioreactor 10 may be released to the outlet 4B, preferably after physical separation of impurities in the separator 12.

The water treatment system 4 comprises for example a reverse osmosis treatment device 14 configured for treating water by reverse osmosis.

In a preferred embodiment, the reverse osmosis treatment device 14 is arranged to treat water previously treated in the bioreactor 10.

In another embodiment, the water treatment system 4 comprises the reverse osmosis treatment device 14 with being deprived of bioreactor.

In still another embodiment, the water treatment system 4 comprises the bioreactor 10 and the reverse osmosis treatment device 14 configured to treat distinct streams of water, e.g. streams of water intended for different uses.

The water treatment assembly 2 comprises a compressed air system 18 configured for producing compressed air and for storing the compressed air.

The compressed air system 18 comprises for example at least one air compressor 20 and at least one compressed air reservoir 22.

The compressed air system 18 is configured for providing the compressed air to the ventilation device 8 and/or to an energy production unit 24 configured for using the compressed air for producing electrical energy.

The energy production unit 24 comprises for example one or several air turbines, each air turbine being configured for using compressed air to generate electricity.

The compressed air system 18 is preferably configured for providing the compressed air stored in the compressed air reservoir 22 to the ventilation device 8 and/or to the energy production unit 24. The ventilation device 8 and/or the energy production unit 24 are fluidly connected to the compressed air reservoir 22 for receiving the compressed air.

Optionally, the compressed air system 18 is configured for providing the compressed air directly from the air compressor 20 to the ventilation device 8 and/or to the energy production unit 24. The ventilation device 8 and the energy production unit 24 are fluidly connected to the air compressor 20 for receiving the compressed air.

The ventilation device 8 comprises equipment such as one or several fans, one or several motors, one or several pumps, one or several pipe and/or one or several valves for ventilating water treated in the water treatment system 4.

The ventilation device 8 is configured for example for generating bubbles in water treated in the water treatment system 4, in particular for generating bubbles for aeration of water and/or for generating bubbles for agitation of water. Bubbles for aeration are generally smaller than bubbles for agitation.

The ventilation device 8 is for example configured for receiving compressed air and using the compressed air for generating the bubbles. The compressed air is used directly (without conversion of energy) for generating the bubbles.

A ventilation device 8 configured for using the compressed air directly for generating bubbles comprises for examples pipes with air outlets and optionally valves for controlling the circulation of air in the pipes.

Alternatively or as a complement, the ventilation device 8 is configured for using electrical energy to produce air bubbles.

In such case, the energy production unit 24 is electrically connected to the ventilation device 8 for providing electrical power to the ventilation device 8.

The compressed air is used indirectly, with a conversion into electricity.

The ventilation device 8 comprises for examples as one or several fans, one or several motors and/or one or several pumps.

Optionally, the energy production unit 24 is electrically connected to one or several other equipment of the water treatment system 4 for providing electrical power to these other equipment.

In particular, the energy production unit 24 is optionally electrically connected to the bioreactor 10, the separator 12 and/or the reverse osmosis treatment device 14 for providing electrical power to them, in particular to equipment such as motor, valves or pumps.

As illustrated on FIG. 1, the energy production unit 24 electrically connected to the ventilation device 8, the bioreactor 10, the separator 12 and the reverse osmosis treatment device 14 via electrical lines illustrated in dotted lines.

As illustrated on FIG. 1, the compressor 20, the compressed air reservoir 22, the energy production unit 24, the ventilation device 8 and the bioreactor 10 are fluidly connected via compressed air lines illustrated in dash-dotted lines.

The water treatment assembly 2 comprises for example an electrical power system 28 configured for producing electrical power with using at least one renewable energy source and for feeding the water treatment system 4 and the compressed air system 18 with electrical power.

The electrical power system 28 is for example configured for producing electrical power using wind energy, geothermal energy, solar energy, wave energy and/or hydraulic energy.

The electrical power system 28 comprises for example at least one wind turbine for producing electrical power using wind energy, at least one geothermal unit for producing electrical power using geothermal energy, at least one photovoltaic panel for producing electrical power using solar energy, at least one concentrated solar thermal power unit for producing electrical power from vapor generated by heating a fluid using concentrated solar energy, at least one wave energy converter for converting wave energy into electrical power, and/or at least one tidal turbine for converting a water stream into electrical power.

The electrical power system 28 is electrically connected to the water treatment system 4 and/or to the compressed air system 18 for providing electrical power to the water treatment system 4 and/or to the compressed air system 18 via the electrical lines, as represented in dotted lines on FIG. 1.

The water treatment assembly 2 comprises a heat management system 30 configured for transferring heat from the electrical power system 28, the electrical power unit 24 and/or the compressed air system 18 to the water treatment system 4.

In operation, the electrical power system 28, the electrical power unit 24 and the compressed air system 18 are likely to generate heat.

Besides, the water treatment system 4 is likely to need heat for operating the water treatments or for improving the efficiency of the water treatments.

The provision of the heat management system 30 enables to take advantage of heat generated by the electrical power system 28, the electrical power unit 24 and the compressed air system 8 for transferring this heat to the water treatment system 4. The energy efficiency of the water treatment assembly 2 is thus improved.

The heat management 30 system comprises for example at least one first heat exchanger 32, each first heat exchanger 32 being configured for collecting heat from one of the electrical power system 28, the electrical power unit 24 and the compressed air system 8.

As illustrated on FIG. 1, the heat management 30 comprises a first heat exchanger 32 configured for collecting heat from the electrical power system 28 and a first heat exchanger 32 configured for collecting heat from the electrical power unit 24.

The heat management system 30 comprises for example at least one second heat exchanger 34, each second heat exchanger 34 being configured for providing heat to the water treatment system 4, in particular to water treated in the water treatment system.

As illustrated on FIG. 1, the heat management system 30 comprises a second heat exchanger 34 configured for providing heat to the bioreactor 10, in particular to water contained in the bioreactor 10, and a second heat exchanger 34 configured for providing heat to the reverse osmosis treatment device 14, in particular to water contained in the reverse osmosis treatment device 14.

The heat management system 30 comprises for example a transfer unit 36 for transferring heat from each first heat exchanger 32 to each second heat exchanger 34. The transfer unit 36 is for example a fluid circuit for the circulation of a heat transfer fluid via each first heat exchanger 32 and each second heat exchanger 34.

In one example, the electrical power system 28 comprises at least one hybrid solar panel comprising photovoltaic cells and an integrated heat exchanger integrated in the hybrid solar panel for collecting heat generating by the photovoltaic cells, the integrated heat exchanger of each hybrid solar panel defining a first heat exchanger 32 of the heat management system 30.

In one example, a first heat exchanger 32 associated to the compressed air system 18 is arranged to exchange heat with an air compressor of the compressed air system 18.

Optionally, the heat management system 30 comprises at least one thermal solar device configured for generating from solar energy.

The heat management system 30 is then configured for transferring the heat generating by each thermal solar device to the water system 4 via the second heat exchangers 34.

The thermal solar device is for example a thermal solar panel or a concentrated thermal solar device configured for heating a heat transfer fluid circulating through the thermal solar panel or the concentrated thermal solar device.

The bioreactor 10 is for example a bioreactor with free biomass, a bioreactor with supported biomass or a photobioreactor.

A bioreactor with free biomass comprises biomass dispersed in the water for treating the water. A bioreactor with supported biomass comprises a support structure that supports biomass, the support structure being immersed in the water to be treated. A photobioreactor uses artificial light or solar light for facilitating photosynthesis of microorganisms in the water to be treated.

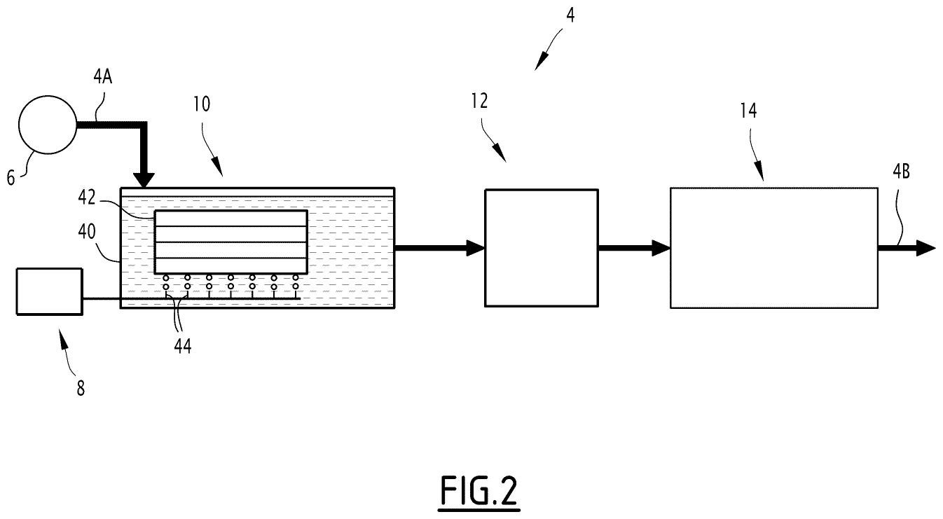

As illustrated on FIG. 2, the bioreactor 10 is a bioreactor with supported biomass and comprises for example a water reservoir 40 into which is provided a support structure 42 supporting microorganisms. The support structure 42 is immersed in the water contained in the reservoir 40.

The ventilation device 8 comprises air nozzles 44 provided inside the water reservoir 40 for generating bubbles inside the water reservoir 40 for agitating water and/or for dissolving dioxygen in the water.

The agitation or water and/or the dissolution of dioxygen in the water are beneficial for the microorganisms and for obtained a satisfactory treatment of the water by the microorganisms.

The air nozzles 44 are for example provided such that the air bubbles generated by the air nozzles 44 move upwardly along the support structure 42 supporting the microorganisms.

The support structure 42 comprises for example a plurality of vertical panels arranged parallel to each other with a transverse spacing between the panels (only one panel being visible on FIG. 2).

Alternatively or optionally, the support structure 42 comprises free supportive material immersed in water on the surface of which bacteria attach and grow.

The water treatment assembly 2 is operable for implementing a water treatment method comprising the steps of treating water in the water treatment system 4 with ventilating water in the water treatment system 4 using the ventilation device 8, producing and storing compressed air with the compressed air system 18 with feeding compressed air to the ventilation device 8 and/or to an electrical power unit 24 configured for producing electrical energy from compressed air, producing electrical power with the electrical power system 28 configured to use at least one renewable energy source and to feed electrical power to the water treatment system 4 and/or the compressed air system 18, and transferring heat from the electrical power system 28, the electrical power unit 24 and/or the compressed air system 18 to the water treatment system 4, in particular to water treated in the water treatment system 4.

More particularly, in operation, the electrical power unit 28 generates electrical power using at least one renewable energy source, such as solar energy, wind energy, wave energy or hydraulic energy.

The electrical power unit 28 provides the electrical power to the compressed air system 18 and to the water treatment system 4, in particular to the ventilation device 8, the bioreactor 10, the separator 12 and/or the reverse osmosis treatment device 14.

The production of electrical power is intermittent due to the intermittent availability of the renewable energies such as solar energy, wind energy, wave energy or hydraulic energy.

In an energy storage mode, the compressed air system 18 uses electrical power generated by the electrical power system 28 for compressing air and storing compressed air into the compressed air reservoir 22.

The energy storage mode is operated for example when electrical power system 28 generates electrical power, and in particular when electrical power system 28 generates electrical power in excess for the water treatment system 4, i.e. when the amount of electrical power generated by the electrical power system 28 is greater than the amount of electrical power used by the water treatment system 4.

The compressed air system 18 provides compressed air to the ventilation device 8 which uses the compressed air for generating bubbles and/or to the electrical power unit 24 which uses the compressed air for generating electrical power that is provided to the water treatment system 4.

In one embodiment, the electrical power system 24 provide electricity to the ventilation device 8 which uses the electricity to ventilate water contained in the water treatment system 4, in particular to generate bubbles to the water contained in the water treatment system 4, in particular in the bioreactor 10.

The compressed air system 18 can provide compressed air from the compressed air reservoir 22 to the ventilation device 8 and/or to the electrical power unit 24 even when the electrical power system 28 generates less electrical power than the electrical power used by the water treatment system 4.

The compressed air system 18 thus allows compensating for periods of low production of electrical power by the electrical power system 28.

The ventilation device 8 allows using the compressed air produced by the compressed air system 18, either directly for ventilating water treated in the water treatment system 4, which is energetically efficient, or indirectly via the electrical power unit 24.

The water treatment system 4 comprising a bioreactor 10 is efficient for treating water, in particular for providing highly purified water, for example water for human consumption.

The bioreactor 10 preferably needs a ventilation of the water treated in the bioreactor 10 and combines advantageously with the ventilation device 8.

Advantageously, the water treatment assembly 2 is configured for transportation via road, sea and/or air.

To this end, the water treatment system 4, the compressed air system 18, the electrical power system 28, the heat management system 30, and, if applicable, the electrical power unit 24, are for example housed in one standardized transport container 60 or several standardized transport containers configured for being mutually connected with electrically and/or fluidly connecting the water treatment system 4, the compressed air system 18 and the electrical power system 28 and, if applicable, the electrical power unit 24 together.

For illustrative purposes, the water treatment system 4, the compressed air system 18, the electrical power system 28, and the heat management system 30 are housed in one standardized transport container on FIG. 1. Alternatively, they are housed in several standardized transport containers interconnected for operation of the water assembly.

A “standardized transport container” is a container specifically designed for road, rail and/or sea transportation. Such a container is also referred to as an “international transport container” or “intermodal transport container” or “maritime transport container”.

A standardized transport container is for example manufactured in accordance with the ISO 668 standard and/or the ISO 1496 standard.

Each standardized transport container has corner pieces located at the eight vertices of a rectangular parallelepiped. These corner pieces are precisely spaced anchor openings, in particular standardized openings respecting the ISO 1161 standard. These corner pieces are used to secure the standardized transport containers to a transport platform and/or to secure the standardized transport containers to each other.

Each standardized transport container is for example 10 feet, 20 feet, 30 feet, 40 feet or 45 feet in length. As known, 1 foot corresponds to 30.48 cm.

The water treatment assembly 2 with the water treatment system 4, the compressed air system 18, the electrical power system 28, the heat management system 30, and, if applicable, the electrical power unit 24, are housed in one standardized transport container 60 or several standardized transport containers can easily be transported to any location where the water treatment assembly 2 is needed, e.g. because of a lack of water infrastructure, e.g. after a disaster, in an isolated area or for dedicated operations.

1. A water treatment assembly comprising a water treatment system configured for treating water, the water treatment system comprising at least one ventilation device for ventilating water treated in the water treatment system, a compressed air system configured for producing and storing compressed air, the compressed air system being configured for feeding compressed air to the ventilation device and/or to an electrical power unit configured for producing electrical energy from compressed air, and an electrical power system configured for producing electrical power with using at least one renewable energy source and for feeding the water treatment system and the compressed air system with electrical power,
wherein the water treatment assembly comprises a heat management system configured for transferring heat from the electrical power system, the electrical power unit and/or the compressed air system to the water treatment system.

2. The water treatment assembly according to claim 1, wherein the water treatment system comprises a bioreactor, the ventilation device being arranged for ventilation of water treated in the bioreactor.

3. The water treatment assembly according to claim 2, wherein the water treatment system comprises a separator fluidly connected to the bioreactor for physically separating impurities from water treated in the bioreactor.

4. The water treatment assembly according to claim 2, wherein the bioreactor is a bioreactor with free biomass, a bioreactor with supported biomass or a photobioreactor.

5. The water treatment assembly according to claim 1, wherein the water treatment system comprises a reverse osmose device configured for purifying a water stream by implementing reverse osmosis.

6. The water treatment assembly according to claim 1, wherein the compressed air system comprises at least one compressor configured for compressing air and at least one air reservoir for storing compressed air.

7. The water treatment assembly according to claim 1, wherein the electrical power unit is configured for providing electrical power to the ventilation device.

8. The water treatment assembly according to any claim 1, wherein the ventilation device is configured for generating air bubbles using electrical power.

9. The water treatment assembly according to claim 1, wherein the ventilation device is configured for generating air bubbles using compressed air provided by the compressed air system.

10. The water treatment assembly according to claim 1, wherein the electrical power system comprises at least one wind turbine for producing electrical power using wind energy, at least one geothermal unit for producing electrical power using geothermal energy, at least one photovoltaic panel for producing electrical power using solar energy, at least one concentrated solar thermal power unit for producing electrical power from vapor generated by heating a fluid using concentrated solar energy, at least one wave energy converter for converting wave energy into electrical power and/or at least one tidal turbine for converting a water stream into electrical power.

11. The water treatment assembly according to claim 1, wherein the heat management system comprises at least one heat exchanger arranged for collecting heat from the electrical power system, the electrical power unit or the compressed air system and at least one heat exchanger arranged for releasing heat to water present in the water treatment system.

12. The water treatment assembly according to claim 1, configured to be transported via road, sea and/or air.

13. The water treatment assembly according to claim 1, wherein the water treatment system, the compressed air system, the electrical power system, and the heat management system are housed in one normalized transport container or several normalized transport containers configured for being mutually connected for connecting the water treatment system, the compressed air system and the electrical power system together.

14. A water treatment method comprising the steps of treating water in a water treatment system with ventilating water in the water treatment system using a ventilation device, producing and storing compressed air with a compressed air system with feeding compressed air to the ventilation device and/or to an electrical power unit configured for producing electrical energy from compressed air, producing electrical power with an electrical power system using at least one renewable energy source and feeding electrical power to the water treatment system and/or the compressed air system, wherein the water treatment method comprises transferring heat from the electrical power system, the electrical power unit and/or the compressed air system to the water treatment system.
